(19) United States
(12) Patent Application Publication
(10) Pub. No.: US 2020/0139170 A1
(43) Pub. Date: May 7, 2020

(54) USE OF LOW-SPARKING MATERIAL WHEN HANDLING BULK GOODS

(71) Applicant: BAYER AKTIENGESELLSCHAFT, Leverkusen (DE)

(72) Inventors: Werner ZIMMERMANN, Wachtberg (DE); Rolf HUFSCHMIDT, Bergisch Gladbach (DE); Claus-Diether WALTHER, Krefeld (DE)

(21) Appl. No.: 16/631,024

(22) PCT Filed: Jul. 23, 2018
(86) PCT No.: PCT/EP2018/069897

§ 371 Date: Jan. 14, 2020

(30) Foreign Application Priority Data
Jul. 28, 2017 (EP) 17183761.0

(51) Int. Cl. A62C 3/04; C22C 9/01

(52) U.S. Cl. CPC A62C 3/04; C22C 9/01

(57) ABSTRACT

The invention relates to an apparatus for handling bulk material which contains fines which can lead to formation of explosive dust/air mixtures, where the apparatus comprises moveable internals in a housing which comes into contact with bulk material, characterized in that the moveable internals and/or the interior of the housing which comes into contact with bulk material consist of aluminum bronzes or are lined and/or coated with the aluminum bronzes.

The invention relates to a solution for the handling of bulk material containing fines which can lead to formation of explosive gas/air mixtures.

The handling of bulk material with which the present text is concerned relates exclusively to procedures which are not material-transforming (i.e. no chemical reaction occurs) or in which there is not intentionally any change in the state of matter.

For the purposes of the present invention, the term bulk material refers to a particulate or lumpy mixture of natural and/or synthetic origin which is present in pourable form. Such materials encompass, for example:
Foodstuffs
Polymers
Fertilizers
Active compounds
Medicaments in solid administration form
Fuels
Combustible dusts

the following plant components (hereinafter referred to as “units”) are, inter alia, used for handling bulk material:
Apparatuses for discontinuous and continuous agglomeration,
Double dump valves,
Metering and transport screws including metering balances with internal transport screw,
Rotary valves,
Granulators,
Metal separators,
Mixers (dynamic, discontinuous and continuous),
Comminution units such as crushers,
Mills,
Deagglomerating units (e.g. sieve mills),
Abrasion units,
Tube chain conveyors,
Sliders (including flat slide valves),
Dryers (discontinuous and continuous),
Vibratory tables and funnels,
Switching points in transport systems,
Screw conveyors,
Star feeders.
Tableting pressers.

This listing does not claim to be complete.

The abovementioned units comprise movable parts such as rotors (cellular wheels), slider plates, screws, screw conveyors, tube chains and also static parts such as housings, guide plates. These parts are typically made of metallic materials. Apart from metallic materials, nonmetallic materials (e.g. polymers, ceramics) are used in the abovementioned plant components both for the movable parts and also for the housings.

In the abovementioned units, formation of explosive mixtures due to dusts can occur both in normal operation and also in the event of malfunctions. The probability of the occurrence of an explosive dust/air mixture in these units can range from “rare and short-term” (corresponding to a zone 22) to “occasional” (corresponding to a zone 21), to “continual, long-term or frequently recurring” (corresponding to a zone 20) (Technical Rules for Operational Safety—TRBS 2152, Hazardous Explosive Atmosphere—General—of Mar. 15, 2006).

On contact of the movable parts with one another, against foreign bodies and/or against the interior wall of the housing concerned, mechanical sparks which can cause ignition can occur.

According to DIN EN 1127-1 (Explosive Atmospheres—Explosion Prevention and Protection part 1 Basic concepts and methodology, 2011 version), mechanically generated sparks are among the 13 types of ignition source mentioned there. It is stated there that: “Particles can be detached from solid materials by frictional, impact and ablation events, e.g. grinding, and these acquire an elevated temperature as a result of the energy expended in the parting procedure. If the particles consist of oxidizable materials, e.g. iron or steel, they can undergo an oxidation process and attain even higher temperatures. These particles (mechanical sparks) can ignite combustible gases and vapors and also certain (remark by the authors: ignition-sensitive) dust/air mixtures (e.g. metal dust/air mixtures). Friction, even between similar ferrous metals and between particular ceramic materials, can also bring about local heating and sparks similar to the grinding sparks. Explosive atmospheres can be ignited thereby.” This also applies to explosive mixtures pursuant to the hazardous material regulations (Regulations for protection against hazardous materials (also referred to as GefStoffV) of Jun. 1, 2015).

In the simultaneous presence at the same place of an explosive mixture and a mechanical spark as ignition source, an explosion can occur in the unit concerned, possibly with propagation of the explosion into upstream and downstream plant components (e.g. pipes, feed devices and discharge devices). Such an explosion can cause harm to persons and/or material damage.

One possible way of avoiding an explosion in the abovementioned plant components is to avoid the explosive mixture in the interior of the abovementioned plant components, e.g. by making these inert.

A further possible way of avoiding an explosion is the avoidance of ignition sources.

A person skilled in the art will know that mechanically generated sparks (impact and frictional sparks) can be avoided when the relative velocity of the movable internals between one another and/or relative to the housing wall is less than 1 m/s (see DIN EN ISO 80079-36: December 2016—chapter 6.4.3). However, this can considerably restrict the utilization of a unit. For process engineering reasons, it is frequently necessary to use relative velocities of significantly more than 1 m/s.

As indicated above, mechanically generated sparks can arise by contact of the movable parts in the interior of the units between one another and/or against the interior wall of the housing. In addition, the occurrence of mechanically generated sparks can also be caused by metal pieces unintentionally introduced into the unit, which can strike both against one another and against the movable and also fixed parts (including housing wall).

It was therefore an object of the invention to provide a solution in order to reliably prevent an explosion in the interior of one of the abovementioned units, which allows utilization of the plant at relative velocities between parts moved relative to one another of up to ≤20 m/s. As a result of this ignition source avoidance, it would be possible, unless required by other circumstances, to dispense with making the abovementioned unit or upstream and downstream parts of the plant inert.

It is known from the literature that, subject to particular prerequisites, mechanical sparks which can cause ignition do not occur in the case of some materials and pairings of materials—see, for example, Henrikus Steen “Handbuch des Explosionsschutzes”, Verlag Wiley-VCH, Weinheim 2000, ISBN 3-527-29848-7; Heinz Helmuth Freytag “Handbuch der Raumexplosionen”, Verlag Chemie GmbH, Weinheim 1965; BGI 533 (DGUV Information 209-001—Safety when working with hand tools, version: May 2007). This is also indicated in the regulatory publications (see, for example, DIN EN ISO 80079-36: December 2016—chapter 6.4.3; DIN EN ISO 80079-36: December 2016—chapter 6.4.2.1), according to which mechanical sparks do not have to be taken into account as effective ignition source in these cases. These materials include copper (Cu), zinc (Zn), tin (Sn), lead (Pb), some brass alloys (CuZn) and bronze alloys (CuSn).

It is likewise known that materials which count as “low-sparking”, including not only the abovementioned materials but also beryllium bronzes (CuBe) (BGI 533—DGUV Information 209-001—Safety when working with hand tools, version: May 2007) can be used for producing hand-held tools for use in explosion hazard regions of zone 0 and with materials of the explosion group IIC (e.g. chisels, hammers, spanners).

Such materials have hitherto only been used as materials for hand-operated tools.

To achieve the abovementioned objects, aluminum bronzes (CuAl alloys) are used according to the invention as material for the movable internals in the abovementioned units and/or for housings of abovementioned units in order to avoid mechanically generated sparks.

The object has been achieved by an apparatus as claimed in claims 1 to 4.

The interior of the housing which is in contact with product or the movable internals are preferably lined and/or coated with the abovementioned materials. Preference is given to nickel-free aluminum bronzes as material for the abovementioned applications. These have not been previously known for this application. For example, the suitability of a specific nickel-free aluminum bronze, AMPCO 25 from AMPCO Metal S.A. has been examined and proven at the German Federal Physical-Engineering Laboratory (Meyer, L., See conclusion of the research project to examine the ignition effectiveness of mechanical sparks when using bronze, ptb 2015-11). These studies in respect of the ignition effectiveness on mechanically generated sparks on an aluminum bronze indicated that no visible mechanically generated sparks occurred in the relevant range of relative velocity and contact pressure. Even ethene/air mixtures, which are significantly more ignition-sensitive than dust/air mixtures in respect of mechanically generated sparks, could not be ignited. However, due to the temperatures occurring at the friction pin, hydrogen/air mixtures, which are even more ignition-sensitive than ethene/air mixtures, could be ignited.

L. Meyer writes: “The experiments showed that when the bronze alloy was rubbed against the chromium steel at velocities in the range from 1 m/s to 20 m/s and contact pressures in the range from 1 N/mm² to 40 N/mm², no mechanically generated sparks were able to be observed. [ . . . ] In ignition experiments using ethene, no ignitions could be brought about when using friction partners from among the present materials.”

It can be deduced from this result that not only the materials mentioned in (DIN EN ISO 80079-36: December 2016—chapter 6.4.3; /5/DIN EN ISO 80079-36: December 2016—chapter 6.4.2.1) copper (Cu), zinc (Zn), tin (Sn), lead (Pb), some brass alloys (CuZn) and bronze alloys (CuSn)) but also aluminum bronzes are suitable as material or material for lining or coating of units and/or for the moving internals thereof in respect of avoidance of effective ignition sources (here mechanically generated sparks and small hot surfaces) up to relative velocities of 20 m/s and contact pressures of 40 N/mm², and this combined with good wear properties. The patent application further provides for the use of aluminum bronze as material for at least one movable internal and/or the housing of an apparatus for handling bulk material.

The field of application for the use of aluminum bronze as material for lining or producing housings or for movable elements of the abovementioned units encompasses the following sectors of industry:
Pharmaceutical industry
Agrochemical industry (including treatment of seed for sowing)
Food industry
Chemical industry
Power stations
Plastics industry
Wood-processing industry

The proposed use of aluminum bronze encompasses the manufacture of the moving and/or static parts of the units for handling bulk materials, both as solid material and as covering (e.g. coating, cladding, adhesively bonded material) on a main element not made of aluminum bronze, by one of the methods customary in the prior art, e.g. cutting-machining shaping according to mechanical requirements.

1. An apparatus for handling bulk material, comprising movable internals in the interior of a housing which comes into contact with bulk material, wherein the movable internals and/or the interior of the housing which comes into contact with bulk material consist of an aluminum bronze or various aluminum bronzes or are lined and/or coated with an aluminum bronze or various 5 aluminum bronzes.

2. The apparatus as claimed in claim 1, wherein the interior of the housing which comes into contact with product or the movable internals are lined and/or coated with the aluminum bronzes.

3. The apparatus as claimed in claim 1, wherein the aluminum bronze is nickel-free.

4. The apparatus as claimed in claim 3, wherein the aluminum bronze is AMPCO® 25.

5. A product comprising aluminum bronze as a material for at least one movable internal and/or the housing of an apparatus for handling bulk material.
